(19) United States
(12) Patent Application Publication
(10) Pub. No.: US 2024/0003096 A1
(43) Pub. Date: Jan. 4, 2024

(54) DEVICE FOR MILLING A PROFILE, ASSOCIATED METHOD AND REFERENCE BODY

(71) Applicant: Schweerbau International GmbH & Co. KG, Stadthagen (DE)

(72) Inventor: Frank Mevert, Lauenhagen (DE)

(21) Appl. No.: 18/258,088

(22) PCT Filed: Nov. 26, 2021
(86) PCT No.: PCT/EP2021/083206

§ 371 Date: Jun. 16, 2023

(30) Foreign Application Priority Data
Dec. 22, 2020 (DE) 10 2020 134 658.1

(51) Int. Cl. E01B 31/13; B23C 5/24; B23C 5/06

(52) U.S. Cl. CPC E01B 31/13; B23C 5/2482; B23C 5/06; B23C 5/2472; B23C 2245/00

(57) ABSTRACT

A device for milling a profile of a rail track intended for rail-bound vehicles includes at least one milling body that is capable of being driven in a rotationally movable manner about an axis of rotation, and a plurality of cutting plates attached to the at least one milling body. At least some of the cutting plates are capable of being pretensioned non-positively for fixing in a respective receiver by at least one clamping body against an abutment as a stop. The at least some of the cutting plates are capable of being deflected in the respective receiver in a radial and/or axial direction by an adjusting means and are capable of being fixed in an adjusted position by the clamping body. The adjusting means is configured to be movable and/or deformable by a pressure transmission fluid.

### CROSS REFERENCE TO RELATED APPLICATIONS

This application is a U.S. National Phase application under 35 U.S.C. § 371 of International Application No. PCT/EP2021/083206, filed on Nov. 26, 2021, and claims benefit to German Patent Application No. DE 10 2020 134 658.1, filed on Dec. 22, 2020. The International Application was published in German on Jun. 30, 2022 as WO 2022/135832 A1 under PCT Article 21(2).

### FIELD

Embodiments of the present invention relate to a mobile device, which is designed in particular as a rail-bound vehicle, for milling a profile, in particular of a rail track intended for rail-bound vehicles. Embodiments of the present invention further relate to a method and a reference body for use in the device.

### BACKGROUND

Due to the relatively high axle loads and high travel speeds, rails are often stressed up to the yield point of the rail material and thus are subjected to wear which has a negative effect on the profile of the running surface of the rail head.

To remove the ripples and corrugations produced on the running surface of rail tracks during operation, which stimulates the wheel sets of the vehicles to vibrate, which disrupts the smooth running of the vehicles and causes an excessive wear of the track superstructure and the vehicles and can produce whistling driving noises, post-machining is needed according to the degree of wear.

To this end, for example, a method for machining railroad tracks is known in which a plurality of rotating grinding wheels is used, the grinding wheels being arranged adjacent to one another and behind one another, wherein some of the grinding wheels are inclined according to the original profile of the rail heads. With such a grinding method, it is possible to achieve an improved approximation to the original profile of the rail heads.

Grinding systems, which are brought into engagement with the rail surface on the front face and are preferably set at a tilting angle relative to the rail surface to be ground, are also known.

EP 2 525 933 B1 refers to a device for material-removing post-machining of the running surface of a rail head with a chassis guided along the rail head. The machining tools are configured as face milling cutters which can be driven so as to be rotatable in opposing directions, the axes of rotation thereof running in a common plane and the cutting regions thereof overlapping one another transversely to the longitudinal direction of the rail head.

To increase the machining speed, it is disclosed in DE 32 22 208 A1, for example, to use milling cutters, the cutting edges thereof which are distributed in a plurality of axial groups over the periphery of the blade head replicating the rail head profile.

The arcuate cutting path of the individual cutting edges of the milling cutter caused by such peripheral milling, however, leads to a surface of the rail head which is corrugated in the rail longitudinal direction, wherein the surface quality is impaired with an increasing feed rate due to the increasing distance between the material removing devices of successive cutting edges.

WO 02/06587 A1 also describes a method for re-profiling at least the convex part of the rail head cross-sectional profile of a rail by peripheral milling, with more than five milling tracks adjacent to one another in the longitudinal direction of the rail.

Further devices for material-removing post-machining, in particular for milling rail heads laid in the track, are described in the publications EP 0 952 255 B1, U.S. Pat. No. 5,549,505 A, EP 0 668 398 B1, EP 0 668 397 B1, U.S. Pat. No. 4,275,499 A and EP 0 148 089 A2.

Devices are also disclosed, for example, in DE 28 41 506 C2 in which the rail heads are machined with a so-called rail planer. A drawback when planning, primarily compared to the milling method, is a relatively long machining time due to the repeated passes needed over the rail portion to be machined.

AT 400 863 B describes a device for material-removing post-machining of a rail head by means of a revolving tool which is guided along the machining strip, in which the cutting edges are held in supports which form links of a link chain endlessly guided about deflection wheels.

WO 2020/190 498 A1 refers to a method for grinding rails in which the removal is determined on the basis of data relating to the physical state of each rail and a desired rail profile. An individual grinding profile for each rail segment is created therefrom, the grinding profile also taking into account the configuration of the individual grinding modules and the individual grinding reference values of the individual grinding modules. The grinding pattern defined by the user can contain the determination of a maximum operating speed at which the rail grinding machine passes over the rail.

In the milling cutters for hobbing known from the prior art, the cutting plates are arranged, for example, in a horizontal position, so that the cutting plates are placed with their main surface on the support and can be fixed by means of a fixing screw through a through-hole of the cutting plate (indexable insert) in combination with a spacer plate for adjusting the height. For example, eight cutting plates cover the entire transverse profile, wherein these cutting plates are offset in the peripheral direction and thus come into engagement one after the other. When machining a rail track by means of milling cutters, a significant amount of material is removed but the surface quality thus generated requires post-machining by finishing. In contrast, a smaller amount of material is removed by the known grinding methods than by milling, but higher feed rates can be achieved during grinding so that in practice due to the respective boundary conditions both milling and grinding methods are used.

Thus it is currently usual to machine the rails in one operation with a milling cutter and to reduce the machining marks which occur on the machined surface as a result of the milling, such as corrugations or track patterns, by grinding.

### SUMMARY

Embodiments of the present invention provide a device for milling a profile of a rail track intended for rail-bound vehicles. The profile has a running surface and a side surface. The device is movable in a feed direction along a longitudinal extent of the profile. The device includes at least one milling body that is capable of being driven in a rotationally movable manner about an axis of rotation, and a plurality of cutting plates attached to the at least one milling body. At least some of the cutting plates are capable of being pretensioned non-positively for fixing in a respective receiver by at least one clamping body against an abutment as a stop. The at least some of the cutting plates are capable of being deflected in the respective receiver in a radial and/or axial direction by an adjusting means and are capable of being fixed in an adjusted position by the clamping body. The adjusting means is configured to be movable and/or deformable by a pressure transmission fluid.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a milling body of a device with a plurality of cutting plates according an embodiment;

FIG. 2 shows a perspective view of the open milling body with an arrangement of the cutting plates on an alignment surface according an embodiment;

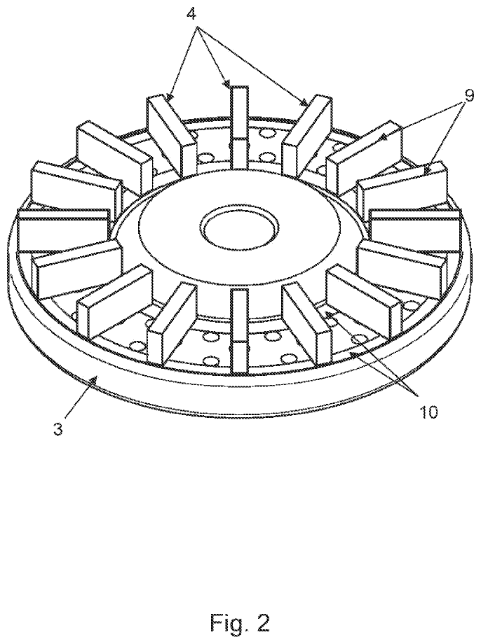

FIG. 3 shows a perspective view of the milling body from a rear view according an embodiment;

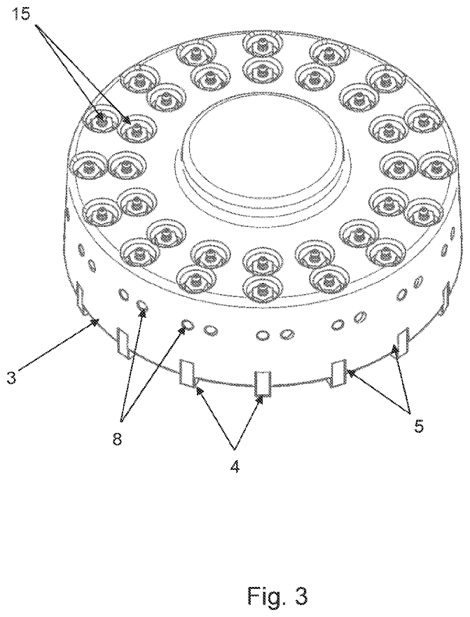

FIG. 4 shows a side view of the milling body in combination with a reference body for aligning the cutting plates according an embodiment;

FIG. 5 shows a longitudinal section through the milling body and the reference body along the line V-V in FIG. 4, according an embodiment;

FIG. 6 shows a sectional side view of a variant of the milling body with adjusting means coupled in pairs by fluid channels, according an embodiment; and

FIG. 7 shows a sectional side view of a further variant of the milling body with centrally connected adjusting means in connection with the reference body, according an embodiment.

### DETAILED DESCRIPTION

Embodiments of the present invention provide a mobile device, which is designed in particular as a rail-bound vehicle, for milling a profile, in particular of a rail track intended for rail-bound vehicles, and which has a convex running surface and a side surface defining the profile, wherein the device is movable in a feed direction along the profile and has at least one milling body, with a plurality of cutting plates, which can be driven in a rotationally movable manner about an axis of rotation and which is arranged on a support, and wherein at least some of the cutting plates are able to be non-positively applied and releasably fixed in one respective receiver by means of at least one clamping body against a stop as an abutment acting or supporting in the peripheral direction. Embodiments of the invention further relate to a method and a reference body for use in the device.

Embodiments of the invention provide a possibility of being able to fulfill higher requirements in terms of accuracy in the milling of profiles, in particular of a rail track intended for rail-bound vehicles.

In particular, deviations which occur are intended to be reduced to a few 1/1000 mm, so that it is possible to dispense with post-machining the milled profiles.

According to some embodiments, a device is provided in which at least some of the cutting plates can be deflected in their respective receiver in the radial or axial direction, in particular steplessly, by means of an adjusting means which can be movable and/or deformable in the radial or axial direction by a pressure transmission fluid, in particular a hydraulic fluid, such as for example a hydraulic oil, and which to this end for example can have at least one, in particular translationally movable, piston, and can be fixed non-positively in the adjusted position by means of the clamping body without changing the orientation. According to embodiments of the invention, it is possible for the first time that, when the machining of the profile by means of a milling body is at a standstill, with cutting plates arranged on the periphery or front face, the high requirements applicable to rail tracks for avoiding undesired corrugation patterns without post-machining, and in particular without a post-machining step which in practice was previously unavoidable, are reliably fulfilled by grinding. The machining of the profile can be carried out with deviations of less than 1/100 mm. In the milling process which is thus improved according to embodiments of the invention, in principle the intrinsic technical advantages of milling, in comparison with grinding, such as in particular the high removal capacity and the low heat development during machining, are maintained in an unlimited manner. However, in contrast to the grinding method, a defined removal can be adjusted as a cutting depth which can also be dimensioned differently in different tracks or portions of the transverse profile of the rail. The material removal can be specifically limited, for example, to those regions of the transverse profile of a rail track which require post-machining, so that if needed the removal of material can be reduced as a whole. The removed material which is generated is additionally absorbed without leaving any residue so that an undesired input of material into the track is avoided.

The low tolerances which can be achieved according to embodiments of the invention cannot be achieved by the possibility, which is known per se, of height compensation or adapting the relative radial positions of different, primarily adjacent, cutting edges of the same milling body by means of spacers. Rather, for practical reasons it would already be impossible to use spacers for compensating for deviations in the region of a few 1/1000 mm. Accordingly, by the individual adjustment of the different cutting plates by one or more pistons or rams of the adjusting means, by changing the pressure of a pressure transmission fluid which is intended for deflecting the pistons and which is indirectly or directly connected thereto, according to embodiments of the invention the conditions are provided for such a possibility for precise adjustment which could not be achieved by means of a purely mechanical adjustment or fixing of the cutting plates.

It has been shown that by separating the functions of the displacement of the cutting plate, which can be achieved by the adjusting means, into the desired reference position, on the one hand, and the clamped and thus the stepless fixing of the position of the cutting plate thus adjusted by means of the clamping body, on the other hand, the conditions can be provided for fulfilling such high requirements for accuracy.

Moreover, a relatively small space requirement of the device is achieved by the adjustment means which act on the cutting plate being connected only by a line connection for the pressure transmission fluid to a pressure generating means which is spatially separated therefrom, as needed, whereby a compact design of the adjusting means can be implemented. Additionally, the device has a low dead weight and requires only small structural modifications to the milling body. Moreover, a good accessibility is achieved, due to the spatially separated arrangement of the pressure generating means from the respective cutting plate. Due to the small space requirement, a larger number of cutting plates can be arranged so as to be distributed over the periphery in one respective track on an existing surface, in particular the peripheral surface of the milling body, than was previously usual or possible in practice. Since the feed for each cutting plate is limited during the machining of the profile, a correspondingly larger number of cutting plates can also increase the feed relative to a full revolution of the milling body, so that the feed rate can also be increased thereby without undesired drawbacks regarding undesired corrugations when machining the profile.

It should be noted that the adjusting means is not limited to a movable piston, which can be translationally displaced into different positions in a conventional structural design in a cylinder, as a function of the pressure. Rather, the adjusting means can also bring about the displacement of the cutting plate by a simple elastic deformation, by taking into account the small adjustment paths of the cutting plates to reach the reference position. In this manner, a closed system, which contains the pressure transmission fluid for the deflection of the cutting plates and which thus also does not require a movable piston, can be provided with little effort. In practice, in the broadest sense, any expansion body or expanding body with a correspondingly suitable deformation behavior and which can be deformed counter to an elastic restoring force by the pressure transmission fluid is suitable therefor.

In an embodiment of the invention, the cutting plates inserted in their respective receiver rest on at least one, preferably two, hydraulic rams or pistons of the adjusting means. The required pressure difference for the displacement is generated by introducing, for example screwing in, an adjusting body as a displacer into a line volume enclosing the pressure transmission fluid, and bringing about the deflection or deformation of the adjusting means as a result of the pressure increase in the pressure transmission fluid, wherein the adjustment path of the adjusting body can be monitored or controlled by the adjustment path or by the torque.

An embodiment of the invention is achieved in that, in the case of milling bodies for hobbing, the cutting plates adopt with their main axis a radial orientation in the receiver and are radially aligned with a front face facing away from a cutting edge on a support, which is kinematically coupled to the adjusting means, of the receiver of the cutting plate, or in the case of milling bodies for face milling, correspondingly adopt an axial orientation in the receiver with their main axis.

Each receiver or each cutting plate can be provided with one or more adjusting means which are preferably designed to be structurally the same. Moreover, a plurality of adjusting means can be activated jointly, in particular by a communicating connection of the pressure transmission fluid, or separately in order to be able to adjust the desired reference position of the cutting plates with the desired reproducible accuracy.

The adjusting or adapting of the fluid pressure of the pressure transmission fluid could be maintained by means of a pump, in particular a compressor, and by actuating a shut-off member. However, a variant of the device according to an embodiment is practical in which, for adapting the fluid pressure of the pressure transmission fluid and for actuating the adjusting means in order to displace the cutting plates, the device has at least one adjustable displacement body which acts on the pressure transmission fluid and which in particular changes a line volume of the fluid line receiving the pressure transmission fluid. In a simple variant, the displacement body is formed by a portion of a threaded bolt, so that only a rotational movement is needed in order to change the fluid pressure, wherein the adjustment path is monitored or controlled by the torque.

Naturally, the principle of the hydraulic press can also be used, according to which the forces behave proportionally to the respective surfaces, so that an adjusting body or displacer with a relatively small cross section and the pressure transmission to a piston with a larger cross section leads to a high effective force on the adjusting means or piston.

A variant of the device according to an embodiment has proved advantageous in which a plurality of cutting plates are arranged in each case in parallel tracks, which are assigned in each case to a portion of the transverse profile of the profile. Thus different, possibly also overlapping, portions of the transverse profile can be machined to the desired cutting depth. In practice, optionally the fixing according to an embodiment of the invention of all of the cutting plates can be dispensed with, and individual cutting plates which are less relevant for the transverse profile can be fixed in a conventional manner.

It is also practical if a plurality, in particular all, of the cutting plates of a milling body for hobbing, which are arranged in adjacent parallel tracks, have an offset to one another in the peripheral direction, or in a milling body for surface milling have an angular offset to one another, in order to achieve a uniform distribution of the engagement of the cutting edges in the cutting plates.

A further, also expedient, variant of the device according to an embodiment of the invention is implemented by the clamping bodies being adjustable by means of a screw connection, which is designed either for fixing or for disconnecting the clamping bodies by rotating in opposing directions. By means of the screw connection, which is provided to this end in some portions with opposing threaded portions and designed as a spindle, the cutting plates are not only able to be secured rapidly in the desired reference position but also released from the receiver if needed. With a screw connection provided with a left-hand and right-hand thread, this also facilitates the adjustment of a predetermined fixing force acting on the clamping body.

The device could advantageously be designed as a face milling cutter or surface milling cutter on which the cutting plates are arranged on the front face, and as a peripheral milling cutter or hobber with cutting plates on the periphery of the milling body. In a further variant of the device according to an embodiment of the invention, the cutting plates of the milling body can be adjusted by the adjusting means in their respective receiver merely in those regions of the transverse profile and/or tracks of the milling body in which the transverse profile and/or the cutting edges enclose an acute angle of less than 45° with the axis of rotation of the milling body, which is designed as a hobber or peripheral milling cutter, or in which the transverse profile and/or the cutting edges enclose an angle of more than 15° with the axis of rotation of the milling body which is designed as a face cutter.

In principle, the milling body, which is designed as a hobber or peripheral milling cutter, has a concave shape adapted to the contour of the transverse profile. As a result, in the region of the lateral portion of the transverse profile and the cutting plates, which are assigned to this portion and which are arranged at an angle of between 15° and 90° to the transverse profile, it results in milling which corresponds to face milling, regarding the relative orientation of the cutting plates relative to the surface of the rail to be machined, or permits the machining quality to be achieved. Conversely, the fixing of the cutting plates according to an embodiment of the invention can also be used with surface milling cutters of a corresponding concave shape, primarily in such portions in which the cutting edge encloses a corresponding angle with the cross-sectional plane relative to the axis of rotation.

The object according to an embodiment of the invention is also achieved by a method for positioning, adjusting and/or calibrating at least individual cutting plates relative to the respective receiver of the device by means of the translationally movable adjusting means, by the adjusting means being deflected by a pressure transmission fluid, wherein the fluid pressure is changed by an adjusting body acting as a displacer, and the adjusting means is adjusted thereby until a cutting edge of the respective cutting plate, which faces away from the adjusting means, has reached a desired reference position. The cutting plate is steplessly deflected in the radial direction, in particular, and is fixed non-positively by means of the clamping body in the adjusted radial positions without changing the orientation. The adjusting means is subjected to the pressure transmission fluid and deflected as a function of the pressure, whereby the position of the cutting plate, which is coupled kinematically to the adjusting means as a guide in the receiver, is adjusted. The fixing of the cutting plate is finally carried out by the clamping body, which in a manner known per se non-positively and releasably fixes the cutting plate in a clamped manner, preferably against a stop supporting in the peripheral direction. A suitable pressure transmission fluid is, for example, a hydraulic oil.

Maintaining or adjusting the desired reference position of the cutting plates could be detected or monitored by a contactless measuring system. It is promising, however, when according to a variant of the method according to an embodiment of the invention a plurality of cutting plates are moved one after the other or at the same time with a predetermined force by means of the respective adjusting means against a convex reference body corresponding to the transverse profile to be generated and with a high degree of precision. Regarding the relevant transverse profile, the reference body corresponds to the reference shape of the profile to be generated. It has been shown that by delivering the cutting plates, primarily controlled by force, against the reference body by means of the adjusting means, a surprisingly accurate adjustment of the reference position can be undertaken, in particular also relative to the adjacent cutting plates, without measuring values having to be detected therefor. Additionally, the adjustment of the cutting plates only requires a small manual effort, whereby operating errors are substantially eliminated. The displacement of the individual cutting plates can be carried out according to a predetermined sequence, wherein cutting plates which are spatially spaced apart one after the other, in particular not adjacent to one another, are adjusted.

As a result, a final machining could take place in this portion of the transverse profile, which requires no post-machining, while in the remaining portion of the transverse profile an oversize can be left which is removed by the subsequent surface milling. The milling preferably takes place in synchronism with a feed movement of the vehicle bearing the device relative to the profile, wherein machining in the opposing direction is not excluded.

Such a reference body is designed to be convex for use in a device and/or for carrying out the method and in a defined reference position relative to the device serves as an abutment for at least individual cutting plates, wherein the reference body has a plurality of recesses intended, in particular, for a tool for actuating the clamping body, the clamping body being fixed and the adjusted position being able to be fixed by means of a tool. Embodiments of the invention make use of the recognition that the displacement of different cutting plates against the reference body as an abutment is not only able to be carried out more easily but is also subject to fewer errors than the adjustment of specific positions to be monitored by measuring technology. Accordingly, the cutting plates are moved with a predetermined force against the reference body, according to the transverse profile to be generated, and thus can be adjusted with a high degree of precision.

Preferably, the reference body has recesses through which the clamping body can be fixed and the adjusted position of the cutting plates can be secured by means of a tool.

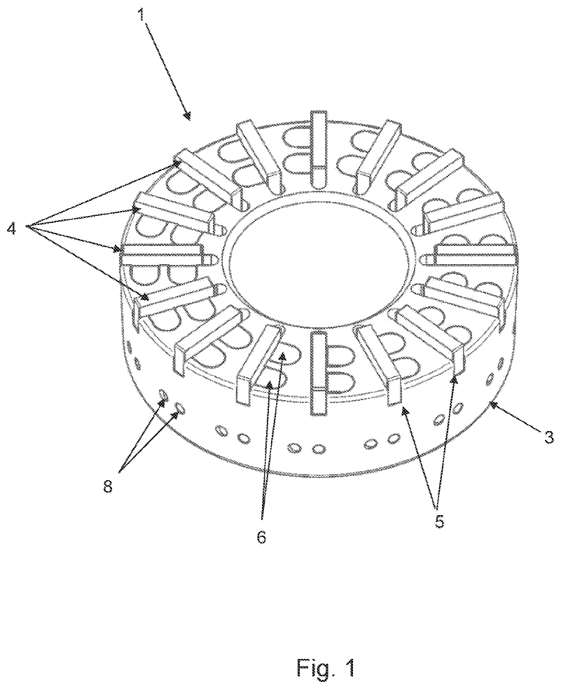

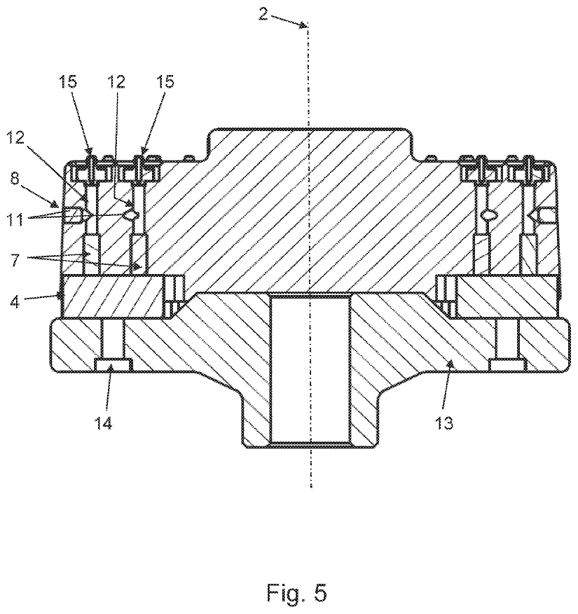

FIG. 1 shows a device 1, which is movable along a longitudinal extent of a profile to be machined and which is not shown, for milling the profile. The device 1 has a milling body 3 which is rotationally movable about an axis of rotation 2 which can be identified in FIG. 5, with a plurality of radial cutting plates 4. The individual cutting plates 4 in each case are able to be non-positively pretensioned independently of one another in one respective receiver 5 by means of a plurality of clamping bodies 6 against a stop, not shown.

According to the embodiments shown and explained below in more detail, each of the different cutting plates 4 is adjustable by two pistons 7 of an adjusting means 8, by the pressure of a pressure transmission fluid acting on the piston 7 being changed, resulting in a deflection of the piston 7 due to this pressure change of the pressure transmission fluid.

The cutting plates 4, with a surface facing away from a cutting edge 9 of the cutting plate 4, are positioned on a support 10 of the receiver 5 which is kinematically coupled to the adjusting means 8.

In this manner, a translational displacement of the cutting plate 4 into the desired reference position is achieved by the adjusting means 8, while the clamped and thus stepless fixing of the position of the respective cutting plate 4 thus adjusted is undertaken by means of the clamping body 6.

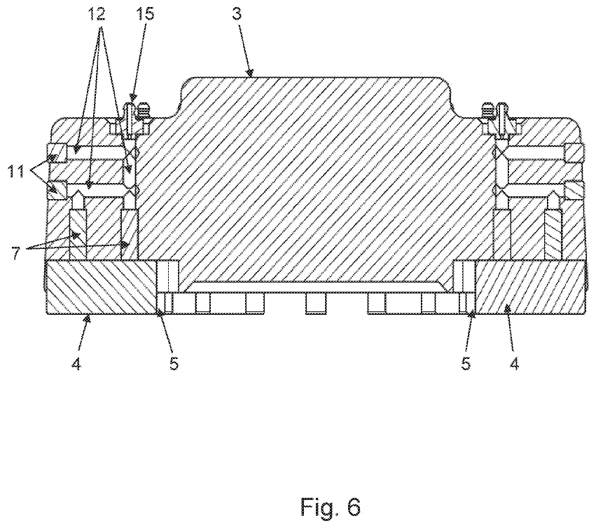

In order to increase the fluid pressure of the pressure transmission fluid, a displacement body 11, which is shown in FIGS. 5 and 6 and which acts on the pressure transmission fluid, is displaced inside a fluid channel 12 which is filled with the pressure transmission fluid. To this end, the displacement body 11 is coupled in some portions to a self-sealing thread, not shown further, in a corresponding threaded receiver in the milling body 3, so that the adjustment of the desired position can be undertaken manually with little effort, for example by means of a torque wrench.

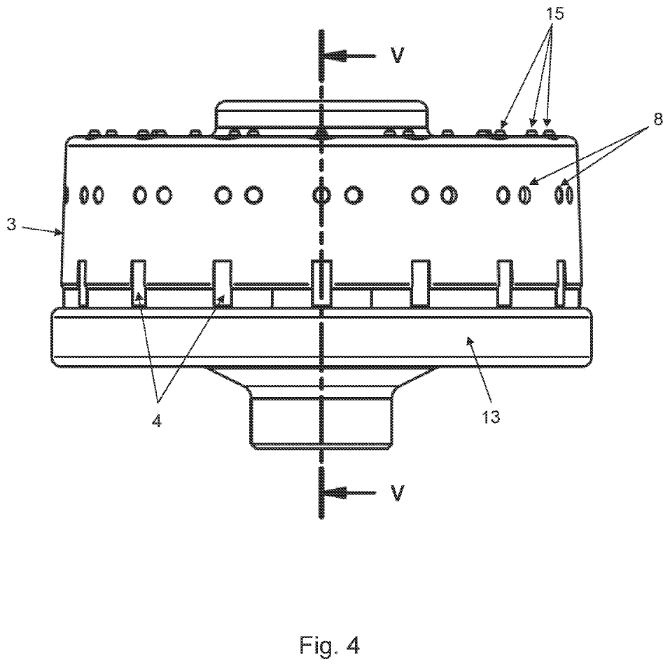

For the adjustment, the fluid pressure is changed by the displacement body 11 and the adjusting means 8 is adjusted thereby until a cutting edge 9 of the respective cutting plate 4 facing away from the adjusting means 8 has reached a desired reference position, in which the respective cutting plate 4 bears with a predetermined force against a reference body 13 shown in FIGS. 4, 5 and 7. The reference body 13 of the device 1 serves as an abutment for all of the cutting plates 4. After the respective cutting plate 4 has reached the predetermined reference position, the clamping body 6 is actuated through a recess 14 in the reference body 13 and thus the cutting plate 4 can be fixed without the reference body 13 previously having to be removed.

In FIGS. 5 to 7 different variants of the device 1 are shown. In FIG. 5 a variant can be identified in which two pistons 7 of an adjusting means 8, which are separated in terms of flow technology, can be actuated with one respective supply line 15, in each case by a separate displacement body 11. Since the pistons 7 are movable independently of one another and asynchronously, the cutting plates 4 resting thereon can be tilted, as needed, at an adjustable angle relative to a cross-sectional plane to the axis of rotation 2.

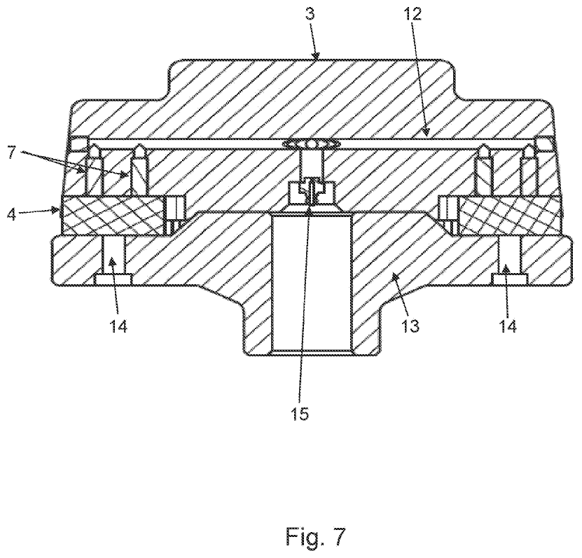

Accordingly, in the variants shown in FIGS. 6 and 7, the pressure acting on the two pistons 7 of a cutting plate 4 is consistent. To this end, two displacement bodies 11 are provided, the two displacement bodies however acting parallel to coupled fluid lines of a common fluid channel 12, so that the fluid pressure is consistent. The two displacement bodies 11 thus act in parallel on both pistons 7 which are supplied with pressure transmission fluid by a common supply line 15, wherein the two displacement bodies 11 can be designed for approximate adjustment, on the one hand, and fine adjustment, on the other hand.

FIG. 7 also shows a further variant in which all pistons 7, and accordingly all cutting plates 4 movable thereby, can be subjected simultaneously to the same pressure by a central supply line 15 of the pressure transmission fluid. In connection with the reference body 13 shown, this results in an internal compensation and a corresponding pretensioning relative to the reference body 13 so that in practice this variant permits a simple and rapid adjustment of all of the cutting plates 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Device
2 Axis of rotation
3 Milling body
4 Cutting plate
5 Receiver
6 Clamping body
7 Piston
8 Adjusting means
9 Cutting edge
10 Support
11 Displacement body
12 Fluid channel
13 Reference body
14 Recess
15 Supply line

1. A device for milling a profile of a rail track intended for rail-bound vehicles, the profile having a running surface and a side surface, wherein the device is movable in a feed direction along a longitudinal extent of the profile, the device comprising:
at least one milling body that is capable of being driven in a rotationally movable manner about an axis of rotation, and
a plurality of cutting plates attached to the at least one milling body, wherein at least some of the cutting plates are capable of being pretensioned non-positively for fixing in a respective receiver by at least one clamping body against an abutment as a stop, wherein the at least some of the cutting plates are capable of being deflected in the respective receiver in a radial and/or axial direction by an adjusting means and are capable of being fixed in an adjusted position by the clamping body, and wherein the adjusting means is configured to be movable and/or deformable by a pressure transmission fluid.

2. The device as claimed in claim 1, wherein each cutting plate has a radial or axial orientation in the receiver with a main axis, and each cutting plate with a surface facing away from a cutting edge of the cutting plate is positioned on a support of the receiver that is kinematically coupled to the adjusting means.

3. The device as claimed in claim 1, wherein a plurality of supports thereof and/or different receivers are capable of being subjected jointly to the pressure transmission fluid.

4. The device as claimed in claim 1, further comprising at least one adjustable displacement body that acts on the pressure transmission fluid for setting a fluid pressure of the pressure transmission fluid.

5. The device as claimed in claim 1, wherein a plurality of cutting plates are arranged in parallel tracks, each track is assigned to a portion of a transverse profile of the profile.

6. The device as claimed in claim 5, wherein the plurality of cutting plates that are arranged in adjacent parallel tracks have an offset to one another in a peripheral direction of the milling body.

7. The device as claimed in claim 1, wherein the clamping bodies are adjustable by a screw connection that is configured either for fixing or for disconnecting the clamping bodies by rotating in opposing directions.

8. A method for adjusting individual cutting plates of a device as claimed in claim 1 relative to the respective receiver of the device, the method comprising:
deflecting adjusting means by a pressure transmission fluid,
changing a fluid pressure of the pressure transmission fluid using a displacement body acting as a displacer, thereby the adjusting means is adjusted until a cutting edge of the respective cutting plate that faces away from the adjusting means, has reached a desired reference position.

9. The method as claimed in claim 8, wherein a plurality of cutting plates are moved with a predetermined force by the respective adjusting means against a reference body.

10. A reference body for carrying out the method as claimed in claim 9, wherein the reference body is configured to be convex, and in a defined reference position relative to the device, the reference body serves as an abutment for the individual cutting plates, and the reference body has a plurality of recesses for a tool for actuating the clamping body.
